(19) United States
(12) Patent Application Publication
(10) Pub. No.: US 2007/0233567 A1
(43) Pub. Date: Oct. 4, 2007

(54) System and Method for Controlled Dispensing and Marketing of Potable Liquids

(76) Inventor: Geoff Daly, Holland, MI (US)

Correspondence Address: CERMAK KENEALY & VAIDYA LLP, 515 E. BRADDOCK RD, SUITE B, ALEXANDRIA, VA, 22314, US

(21) Appl. No.: 11/681,927

(22) Filed: Mar. 5, 2007

Related U.S. Application Data
(60) Provisional application No. 60/743,398, filed on Mar. 3, 2006.

(51) Int. Cl. G07G 1/14; G06Q 30/00

(52) U.S. Cl. 705/14

(57) ABSTRACT

A potable liquid dispensing system includes a data reader that permits unattended beverage tastings, as well as simplified wine dispensing at restaurants and the like. A wine marketing system, including tastings facilitated by the dispensing system, permits a potential buyer of wine to sample small portions of the wine without the assistance or supervision of an employee.

This application claims priority under 35 U.S.C. § 119 to U.S. provisional application No. 60/743,398, filed 3 Mar. 2006, the entirety of which is incorporated by reference herein.

### BACKGROUND

1. Field of the Invention

The present invention relates to devices, systems, and processes useful for the controlled dispensing and marketing of potable liquids, and more specifically to devices, systems, and processes useful to dispense samples of wine both for tasting and for marketing the wine for sale.

2. Brief Description of the Related Art

Wine tastings have long been a way of permitting potential wine buyers to sample one or more wines at a retail establishment, winery, and the like. By providing small sample volumes of a wine, the proprietor can let the potential buyer taste the wine and make an informed buying decision about the wine, which often results in a sale. Because such tastings typically limit the per pour amount of wine to a small amount, e.g., 0.75 oz, there is significantly less chance that the potential buyer would overconsume. Traditional wine tastings are not without difficulties.

Wine tastings have been staffed, which increases the costs to the proprietor for conducting the tasting. Each bottle of wine is repeatedly opened and closed (usually, by recorking), and repeatedly tipped to conduct each pour, resulting in extreme agitation of the wine and, thus, overexposure to oxygen. While the proprietor may wish to boost sales in higher priced wine selections, providing tastings of those wines exposes the proprietor to extra risk: once opened, this wine will become unpalatable because of the aforementioned agitation and oxidation, yet the proprietor may generate no sales from having dedicated the bottle to the tasting. Thus, the proprietor may have to throw away most of an expensive bottle of wine after a tasting.

In bars, taverns, restaurants, and the like, wine is often offered in single glass servings, which often is between five and six U.S. ounces; ‘wine flights’, which are sets of wines selected by a proprietor to be consumed by a customer in series, are often formed of servings of less wine per glass, e.g., 2.5-3.0 ounces per serving. As with wine tastings, however, the repeated agitation and oxidation of the wine by free-pouring the wine degrades the wine, and the proprietor and the customer are interested in knowing that the correct amount of wine is poured.

There remains unmet needs in the areas of wine (and other potable liquid) sales and dispensing for devices, systems, and processes which address these and other shortcomings.

### SUMMARY

According to a first aspect of the invention, a method of marketing at least one potable liquid to a potential buyer comprise positioning a dispensing mechanism in a retail location, the dispensing mechanism including at least one container of the at least one potable liquid, at least one controllable valve controlling the flow of liquid from the at least one container, an electronic control unit in control signal communication with the at least one controllable valve, and a data reader accessible by the potential buyer in data communication with the electronic control unit, reading data from the potential buyer indicating to the electronic control unit that the potential buyer is authorized to use the dispensing mechanism, and dispensing a predetermined volume of the at least one liquid from the at least one container through the at least one valve.

According to another aspect of the present invention, a method of dispensing at least one potable liquid to a buyer from a merchant comprises positioning a dispensing mechanism in a retail location, the dispensing mechanism including at least one container of the at least one potable liquid, at least one controllable valve controlling the flow of liquid from the at least one container, an electronic control unit in control signal communication with the at least one controllable valve, and a data reader in data communication with the electronic control unit, reading data from the merchant indicating to the electronic control unit that the merchant is authorized to use the dispensing mechanism, dispensing a volume of the at least one liquid from the at least one container through the at least one valve, and giving the volume of the at least one liquid to the buyer.

According to another aspect of the present invention, a system useful for controlled dispensing of potable liquid comprises a housing having an exterior and configured and arranged to hold at least one container of a potable liquid, at least one controllable valve configured and arranged to control the flow of liquid from at least one container when positioned in the housing, an electronic control unit in control signal communication with the at least one controllable valve, at least one control switch for each at least one controllable valve, the at least one control switch in signal communication with the electronic control unit, a data reader on said housing exterior in data communication with the electronic control unit, the data reader configured and arranged to read data indicative of a user's authorization to operate the system, wherein the electronic control unit is configured and arranged to enable the at least one controllable valve to dispense liquid therethrough when the data reader communicates to the electronic control unit that data indicative of a user's authorization to operate the system has been read, and when the at least one control switch has been operated.

Still other aspects, features, and attendant advantages of the present invention will become apparent to those skilled in the art from a reading of the following detailed description of embodiments constructed in accordance therewith, taken in conjunction with the accompanying drawings.

### BRIEF DESCRIPTION OF THE DRAWINGS

The invention of this application will now be described in more detail with reference to exemplary embodiments of the apparatus and method, given only by way of example, and with reference to the accompanying drawings, in which:

FIG. 1, including FIGS. 1A-1D, illustrates an exemplary embodiment of a dispensing and marketing device in accordance with the present invention.

FIG. 2, including FIGS. 2A and 2B, schematically illustrates exemplary embodiments of logic in an apparatus and steps in a method in accordance with the present invention.

FIG. 3 schematically illustrates portions of an exemplary embodiment of a system in accordance with the present invention.

### DETAILED DESCRIPTION OF EXEMPLARY EMBODIMENTS

Referring to the drawing figures, like reference numerals designate identical or corresponding elements throughout the several figures.

Aspects of the instant invention include a dispensing, and optionally refrigerating, apparatus that holds containers of one or more potable liquids, e.g., bottles of wine, and permits controlled dispensing of the liquid(s) from the containers. An exemplary apparatus is illustrated in U.S. Pat. No. D491,580, the entirety of which is incorporated by reference herein, and/or advantageously includes the several components of the several models of OZ Winebars™, currently commercially available from OZEM Corp. (Holland, Mich.). In addition, the electronic control of a dispensing and marketing system of the present invention is preferably one that functions as described herein, one embodiment of which is currently commercially available from The Berg Corp. (Madison and Monona, Wis.), including the Laser controllable liquid dispensing systems, and the Infinity™ software system which permits selective control of the dispensing system, data acquisition, and report generation. A more complete description of the Infinity™ software system is contained in the “Infinity™ Installation/Service and User Manual”, available from The Berg Corp. and at berg-controls.com/pdf/infinity.pdf, the entirety of which is incorporated by reference herein as an example of a suitable data management system.

Other aspects of the present invention include that the dispensing system may utilize a programmable activation card system which operates with the controlled dispensing system to permit selective control of the number of pours of one or more liquids held in the apparatus, and/or the amount (volume) of liquid dispensed, both in each individual pour and the total amount of liquid that is dispensed. The card system includes a card reader/writer that is in communication with the dispensing system's logic, and which reads data on a card when inserted therein, and communicates that data to the dispensing system's logic.

Yet other aspects of the present invention include marketing methods for potable liquids at merchants and/or other public locations, which allow restricted pours of potable liquids to persons who have a programmable activation card.

System Card Definitions:

Program Card—assigns a number of drinks or pours per User Card

Calibration Card—calibrates portions

User Card—customers self-dispense preset volumes and preset numbers of tastes

Bar Card—‘opens up’ the system for cardless operation

Program Cards are provided pre-encoded to assign a fixed number of system activations to the User Cards. The Program Card is inserted into the reader/writer and withdrawn. User Cards are inserted immediately afterwards and are programmed or reprogrammed to serve the number of drinks established on the Program Card. For flexibility in the use of the system, it can be advantageous for a merchant user of the system to have several different Program Cards to be able to offer, as examples, a small number (e.g., three) complimentary tastes to walk-in customers, and a larger number (e.g., five or six) of tastes for an affinity club members. It is therefore another aspect of the present invention to define an affinity club for the particular merchant or set of merchants, in which a customer can enroll, for free or for a fee, at least one benefit of which is the use of a User Card to activate a dispensing system as described herein.

Calibration Cards are available in a plurality, e.g., two, types. One Calibration Card offers a global, ‘all taps’ recalibration, and another addresses individual taps. Each Tap of the dispensing system can dispense a different volume by recalibrating the logic of the dispensing system for that tap. The dispensing system can be easily recalibrated through the use of the Calibration Cards to change from a small taste to a more generous flight-sized portion for private tasting functions or even on-premises glass service. In product-sampling applications, establishing such variations in dispensed volumes may be used to reflect or compensate for differences in the values of product being offered for sampling.

An exemplary embodiment of a calibration process can include: inserting one Calibration Card, selecting a tap on the dispensing system, positioning a graduated measure under the tap, and pressing the dispensing button for that tap until the desired quantity of liquid is dispensed. That tap is now programmed in the logic of the dispensing system to dispense, upon a future activation of the tap's dispensing button, the amount of liquid dispensed in this calibration process. Thus, each tap of the dispensing system can be set to differing volumes of dispensed liquid. Using the ‘global’ Calibration Card, performing the same volume calibration on one tap instructs the logic of the dispensing system to preset that same volume for all taps in the system.

User Cards are provided with one side optionally bearing a set of brief operating instructions, e.g., “Insert this card into the slot with this face up”. The opposite side can optionally be reserved for a merchant or company logo and, e.g., a bar code. Included in yet another aspect of the present invention, a marketing system and method includes defining a Member Discount, in which the User Card is presented at checkout from the merchant, scanned to read the discount, e.g., at a POS station, and may optionally be reprogrammed at the checkout using an auxiliary card-refresh (read/write) module. Further alternatively, a marketing system of the present invention can include a time-based subscription to the program. By way of example and not of limitation, a barcode tape can be positioned on the User Card to indicate to a POS system the user's particular activation & expiration dates. Further optionally, the system does not interact directly with the POS system, but rather via UPC product codes assigned to extend benefits and manage a Tasting Program of the present invention through the POS system. A further alternative can include the distribution of token membership cards having any elements of the above-described User (Member) Data, but are not encoded to activate the system. Such non-encoded cards comprise an economical alternative to broad distribution of user cards and would be temporarily exchanged for active, encoded cards when the Member desires to sample products.

(Encoded) User (Member) Cards are programmed to offer a predetermined number of tastes offered to customers of a merchant and/or members of a club as described herein. With each taste, the card is decremented (reduced) by the card reader/writer and the associated logic in the number of available tastes left on the card. While this number could be set to any number, the advantages of limiting the number of tastes to much smaller numbers are self-evident.

Another aspect of the present invention includes that the User Card system can encourage (i.e., cultivate) upgraded liquid, e.g., wine, appetites and generate sales. A marketing system of the present invention thus preferably includes settings the number of tastes to a reasonable daily level (e.g., four or five), at which point, when the User Card is ‘empty’ the customer/member refreshes it or turns it in at the time of checkout. By pre-determining and controlling the number of samples offered, the merchant, particularly those offering alcoholic beverages, can minimize risk and liability exposure of otherwise uncontrolled overindulgence in products made available for sample.

A further benefit of this requisite interactivity with the merchant's sales staff, driven by a system of the present invention, includes increased likelihood of a collateral beverage sale, and the opportunity to verify the consumer's/member's age in the event the User Card was lost or has fallen into possession of a person not of legal age to consume alcoholic beverages in the jurisdiction in which the system is in use.

Yet another aspect of the present invention includes an auxiliary module remote from the dispensing system, for card reloading. The module can be placed at a merchant checkout or service desks, and includes a device into which the User Card can be inserted and having logic configured to reprogram the card's system-actuation functionality, e.g., loading more permitted tastes onto the card's logic. The same card refreshment functionality is preferably incorporated into the dispensing system's logic; however, it is also advantageous to include an additional, remote refresh module to serve sales programs and staff more conveniently.

A Bar Card is a management override card that is inserted into the dispensing system card reader and withdrawn. The Bar Card logic overrides a card-controlled dispensing authentication protocol of the dispensing system's logic, and thus uses of the Bar Card include private tasting functions in which appropriate ID validation (e.g., is of an age permitted in the jurisdiction to consume alcohol) for use of the System is managed via invitation, door checks, or other closed-room controls. Once inserted and withdrawn, the guests can freely activate the system to dispense tastes of the volumes pre-calibrated in the system. Yet another aspect of the present invention includes defining a fee-based subscription club or program, for example, for which the merchant can periodically hold private tastings to build membership in the program. Preferably, the logic associated with the Bar Card deactivates the open bar function when the Bar Card is again inserted and withdrawn.

Associated with the Bar Card functions is the use of the system in on-premises establishments. The Bar Card, as described previously, eliminates the need for member card activations of the machine while offering preset portions of potable liquids, e.g., wines. When the system is set to five or six ounce pours, there is a much better yield from bottles than free pouring. When it is desired to dispense flights of wine, the merchant can calibrate smaller, e.g., 2/2 ounce pours, and press once for dispensing a flight pour and twice for a full (e.g., 5 ounce) glass. The logic of the dispensing system is also designed so that use of the Bar Card enables free-pouring capabilities of the system, offering the dual function of preset portions and free pours. More specifically, the system's logic is configured so that a single press of the dispensing tap button delivers the preset volume, while pressing and holding the tap button will dispense until the button is released.

According to a preferred embodiment of the present invention, an electronic tap rail system replaces the standard manual taps on the device described in the aforementioned U.S. design patent, with a stainless rail in which ‘push-button switches’ and solenoids replace the manual taps at each bottle position. As described above, pushing a tap button dispenses a predetermined amount of wine from the bottle associated with that button.

Yet a further optional feature of a system of the present invention is one or more sets of centrally-located override buttons which enable a change to a different, pre-set portion size. Each override button controls the override of the portion amount for one or more taps; for example, for a dispensing system with two distinct refrigerated and/or holding areas for bottles of wine, one override button is provided for each area's dispensing protocol. As selections are made through the buttons, signals are sent to the electronic control unit (ECU), which is preferably mounted inside the cabinet of the dispensing system. Alternatively, the ECU can be located in another location, and be in communication with the various controls on the dispensing unit itself.

The ECU controls and records dispensing activity. The dispensing system of the present invention can therefore function in a standalone mode, in which the only function of the ECU is portion control or, with the software suite (e.g., Infinity™ suite), generates reports based on labels, price, and volumes. It is also through the software that a POS interface can be established.

Yet another optional feature of the present invention includes the addition of a logical interface, e.g., a general purpose computer having a memory including one or more sets of executable logical instructions, e.g., software, and a user-interface device, such as a touch-sensitive screen, keyboard, pointing device, and the like, which is placed in communication between the ECU and the card reader. Further optionally, the card reader can be one configured to read one of numerous types of cards, such as those bearing only one- or two-dimensional barcodes, biometrics, or the like, in addition or instead of reading a programmable card. According to an advantageous, yet still alternative, embodiment, the logical interface includes a touch screen input device coupled with a general purpose computer that together function as a Point of Sale (POS) device.

In package shops, a “taste” of the wine is known to boost sales. The combination of preservation, optimal serving temperatures, and strong product presentation offered by a dispensing system of the present invention, when deployed in the context of a well-managed package marketing program, enables merchants to cultivate customer's appetites for increasingly upscale wines. Overhead reductions are realized not only through the equipment's wine preservation and conservation capabilities, but also by eliminating the need to have staff-attended tasting, as customers can now dispense their own selections. In order to assure minimal liability exposures, systems of the present invention are advantageously fitted with a data reader, e.g., a card or biometric reader, as described above, that can dovetail into an affinity program for preferred customers or can be issued to any properly validated customer upon request. The card, through the logic contained on the card or identification of the particular card (e.g., by a bar code or the like) and data associated with that identification, determines the number of tastes customers are allowed. The card-control ECU controls the volume of each taste.

The proprietor may, for example, set the volume of tastes at 3/4 ounces and the number of tastes that can be activated on a card to 4 or 5-limiting on-premises consumption to a moderate level, assuring that level is supported by the card control system. Customers can optionally pay for card use or be ‘comp-ed’ according to store policies and subject to local laws that regulate on-premises tastings. The system can therefore work on the basis of permanently-issued ‘membership’ cards and/or per-session cards issued at the proprietor's service desk. Either way, a check-in and refreshing of the card capacity or spot issuance of a ‘fresh’ card gives the proprietor the opportunity to validate the customer (e.g., age, identity) to assure authorized use of the card. In this way, systems and method of the present invention distinguish themselves from uncontrolled free-pour tastings, or cash-controlled card methods that offer no positive consumption limitations. With the card or POS acting as both the facilitating and controlling factor, there is little opportunity for inadvertent (or intentional) over-consumption or the card falling into the wrong hands for unauthorized use.

Among the numerous advantages of the present invention over free-pour tastings are:

Customers, holding the key, have a tangible sense of equity in the program.

Customers feel free to taste wines without feeling staff scrutiny while doing so.

Customers can more casually interact and react socially with each other.

In a social setting, most will tend to upgrade their wine selection.

When offering 1 ounce tastes, there will be 24 customer tastes from a 750 ml bottle, offering unprecedented yield optimization of sample inventories.

The wine will not be agitated 24 times over the life of the bottle, as with free-pour tastings.

The bottle will be handled only twice until empty—during loading and unloading.

The limited time required to change a bottle is a tiny fraction of the time it takes to free pour 24 tastes.

The wine temperatures will be consistently correct for optimal taste.

With loose, open bottles, flavor characteristics degrade within hours of opening, a significant disadvantage of free pour tastings.

The useful life of sample inventories is greatly extended, enabling merchants to offer premium wines they would otherwise be reluctant to offer because of oxidation potential.

Temperature-sensitive wines can be sampled at tasting optimums—unprecedented in conventional wine tasting events.

As the system's preset sampling limits can operate independent of program ‘fees’, there is no possibility that users can over-drink against the limits of a pre-paid cash-value card.

As merchants are likely to also hold closed, or otherwise well-controlled ‘special tasting events’, the system incorporates administrative override features to provisionally suspend the need for User-Card activation and/or dispensed volume limitations.

In the closed systems of the present invention, the taste will be consistent from the first to the last.

There are many other general aspects of the electronically controlled beverage dispensing systems and methods of the present invention. The systems optionally include modems and/or network identification cards (NICs), and associated I/O hardware and software, for remote access to the ECU. When provided, a modem can be permanently connected to a phone line or can be connected on an as-needed basis; NICs are more typically connected to a network, e.g., a LAN, or directly to a high bandwidth modem in communication with the internet. By accessing the ECU remotely through the modem and/or NIC, functions of system can be remotely performed, for example, diagnostics, portion changes, calibration, etc., and also enable operators to retrieve sales data from remote locations. In multi-unit installations, systems of the present invention can be networked, e.g., via conventional ‘daisy-chain’ network architecture, enabling data collection from a single point. Data can be retrieved remotely through the modem/NIC and/or directly through a back-office computing device, e.g., personal computer, running the software (e.g., Infinity™ software). Similarly, output of the sales can be directed to most POS Systems via the Software's POS interface features. Similarly, the logic of the dispensing system is configured so that output of the sales data can be directed to a merchant's POS system through a POS interface module.

In a preferred embodiment, the User Card and the ECU have distinct functions:

(1) The Card determines the number of tastes customers are allowed.

(2) The card-control ECU controls the volume of each taste dispensed.

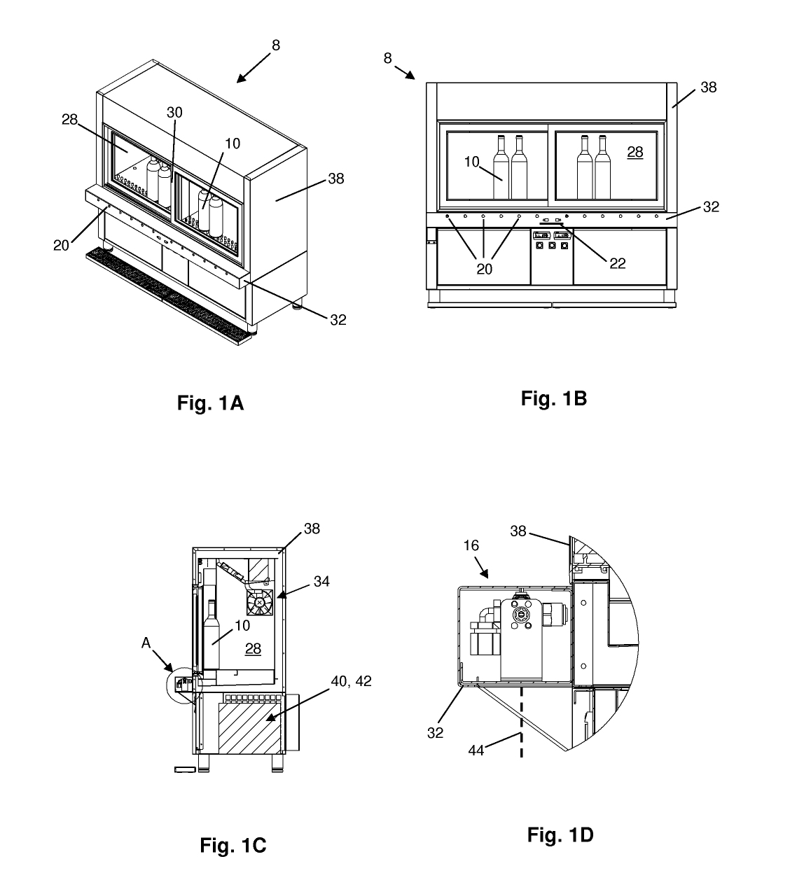

With specific reference to FIG. 1, several views of an exemplary system are illustrated: FIG. 1A illustrates a top, front, right perspective view; FIG. 1B illustrates a front view; FIG. 1C illustrates a sectional view; and FIG. 1D illustrates an enlarged view of portion A, from FIG. 1C. The exemplary system 8 includes bottles 10 of a potable liquid, e.g., wine, contained in the interior space 28 a cabinet 38, in two (optionally) distinctly controlled areas. The cabinet 38 includes one or more doors 30, which are preferably at least partially transparent and slide relative to the cabinet to permit access to the bottles 10 in the interior space 28. A dispensing rail 32 is positioned at the front of the cabinet 38, advantageously below the door(s) 30, which includes at least one, and preferably numerous actuators, e.g., dispensing buttons, 20. The dispensing buttons 20 are preferably spaced apart along the rail and located below the location of each of the bottles 10, activation of which buttons initiates a control signal to a solenoid (or the like) controlled valve 16 to dispense wine from the bottles.

As illustrated in FIG. 1B, the system 8 includes one or more data readers (optionally reader/writers) 22 positioned to be accessible by a user of the system, and particularly preferably on the outside of the cabinet 38. As discussed above, the data reader(s) 22 is selected to read one or more sources of identification data of a user of the system, to permit one or more uses of the system dependent on the type of user. Examples of such data representations include one- and two-dimensional bar codes, programmable magnetic strips carried on a (e.g., credit-card-sized) card, biometric information carried by the user (e.g., a finger having a fingerprint pattern, an eye's iris having a pattern, a voice having a voice pattern), and other such well known data representations, as well as combinations of these data representations. As described elsewhere herein, the data reader(s) 22 are in control signal—or data-communication with other portions of the system 8. Less preferably, yet still within the present invention, the data representation can be a password or passcode that must be communicated (e.g., typed) into the system.

With reference to FIGS. 1C and 1D, the cabinet 38 preferably, yet still optionally, includes one or more environment control systems 34, that is, temperature and humidity control systems, such as those commonly commercially available for refrigerators. As the cabinet 38 can optionally be subdivided up into two or more interior spaces 28 to accommodate different temperature-and-humidity combinations, control systems 34 can be provided for each subdivision or, alternatively, a single control system 34 can be provided which operates to control the environment in each subdivision separately. As such control systems 34 are commonly commercially available and otherwise well understood, further details of the control systems 34 will not be provided herein so as to not obscure aspects of the invention.

An electronic control unit (ECU) 18 and associated communications interfaces are included in the system 8, optionally within the cabinet 38; the function of the ECU is described elsewhere herein. As depicted in FIG. 1D, the tap rail 32 optionally houses the one or more dispensing valves 16, which, when actuated to open by the ECU, dispenses the potable liquid 44 below the tap rail at a lateral position which lines up with the button 20 that corresponds with the particular valve 16. This configuration can be particularly advantageous, because the bottle 10, the button 20 that corresponds to that bottle, and the outlet of the valve 16 that corresponds to that button are lined up vertically, so that the user of the system is confident that the potable liquid that they have selected for dispensing will be dispensed into a vessel (e.g., wine glass, not illustrated) positioned below the valve 16.

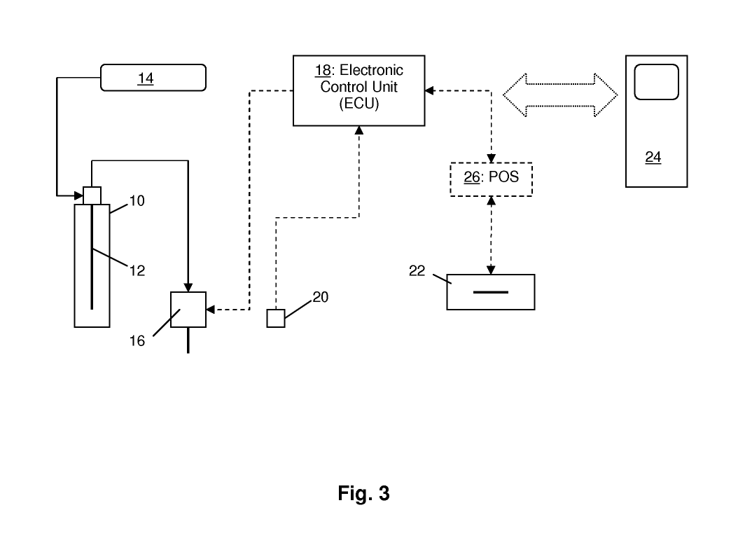

FIG. 3 schematically illustrates an exemplary system in accordance with the present invention. One or more containers 10 of a beverage, e.g., wine, that is to be dispensed is in fluid communication with a corresponding controllable valve 16, e.g., a solenoid controlled valve. The present invention is not restricted to any particular number of containers and valves, although for most purposes between one and 100 sets of containers, valves, and buttons are preferably provided. Optionally, one or more of the containers 10 is in fluid communication with a source 14 of pressurized gas, e.g., nitrogen, argon, or the like, for forcing the liquid contents of the container to the valve, for which purpose the container can be equipped with a suitable dip tube 12, optionally including a filter (not illustrated). When not provided with a source of gas 14, each container 10 can be oriented for gravity flow, e.g., the outlet of the container is oriented down. Each valve 16 is controlled by the ECU 18, as described elsewhere herein. Each dispense button 20 is in communication with the ECU 18, so that when a user of the system activates the button, a signal is transmitted to the ECU and interpreted in the ways described herein, e.g., to open the valve 16 to dispense the beverage from the container that corresponds to that button.

One or more card readers 22 are provided in communication with the ECU 18. The card reader 22 reads a card, as described herein, and communicates data representative of the data carried in the card to the ECU. As card readers are well known to those of ordinary skill in the art, further explanations of the card reader 22 will not be provided so as to not obscure the present invention. The communications link between each of the valve 16, the button 20, and the card reader 22 can be any wired or wireless variety, including, but not limited to, IEEE 1394, 802.11(a), (b), and/or (g), IR, and/or Bluetooth compliant wired and wireless links. Optionally, the ECU 18 can include a transceiver (not illustrated) for this purpose, and thus can communicate with any similarly equipped device. By way of non-limiting example, a handheld device 24, which may be a PDA, mobile telephone, or the like, can communicate with the ECU 18 the data that would have been provided by one or more of the cards described herein. In this manner, a merchant can optionally wirelessly communicate data signals to the ECU to program and control the dispensing of beverages by the system, and/or a customer can wirelessly register with the ECU to enable tastings as described herein.

FIG. 3 also illustrates an optional human interface system 26 in data communication with the ECU 18, and optionally in place of or in communication with the data reader 22. While optional, inclusion of an interface system 26 can provide some advantages in data entry and data display to the user of the system. The logic of the system 26, typically embodied in a set of logical instructions (e.g., software) which are interpreted by a general purpose computing device, e.g., a personal computer, to communicate with the ECU and with a user display, e.g., a touch-screen, permits a user to browse through the selections of wines available for sampling in the system 8, initiate reading of their data through the system itself and/or the reader 22, and thus select the wine they wish to sample. According to a preferable embodiment, the system 26 includes a Point Of Sale (POS) system; one of numerous suitable POS system software is FuturePOS, by Cutting Edge Solutions, Inc. and available from Future POS Ohio (Akron, Ohio). Further optionally, the system 26 includes logic which limits the number of samples taken by a user within a specific time frame. Further optionally, the POS system can be either in parallel with the ECU, recording data and presenting information to the user, but not controlling operation of the system; or integrated with the other parts of the system, as described elsewhere herein.

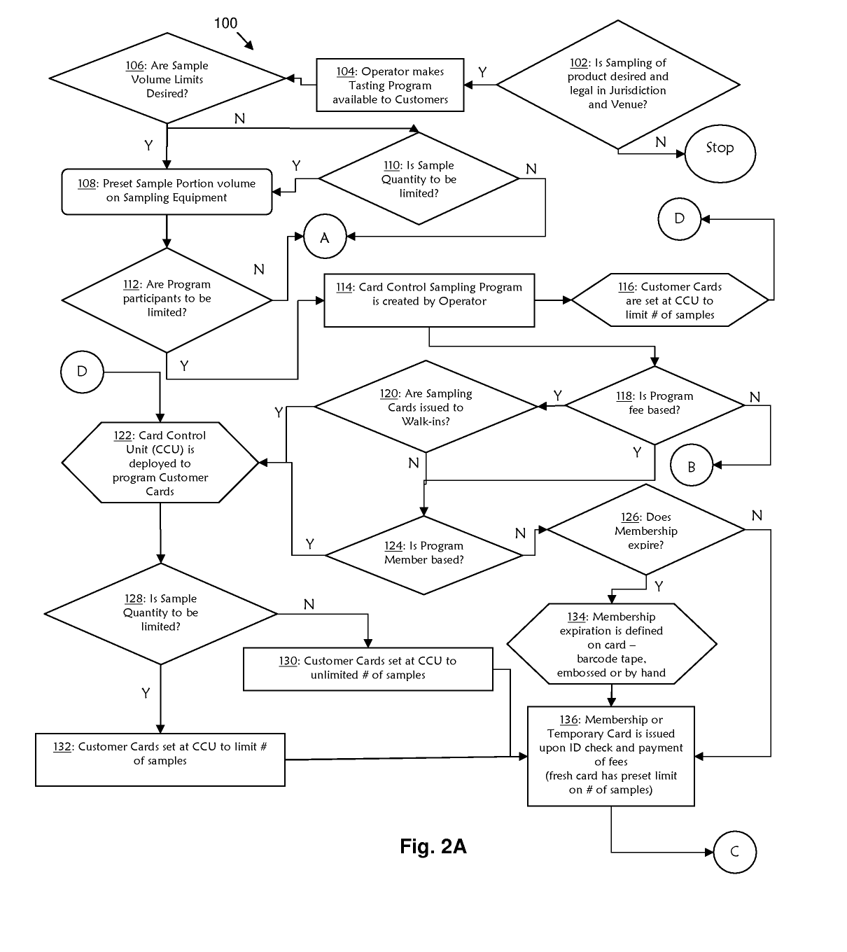

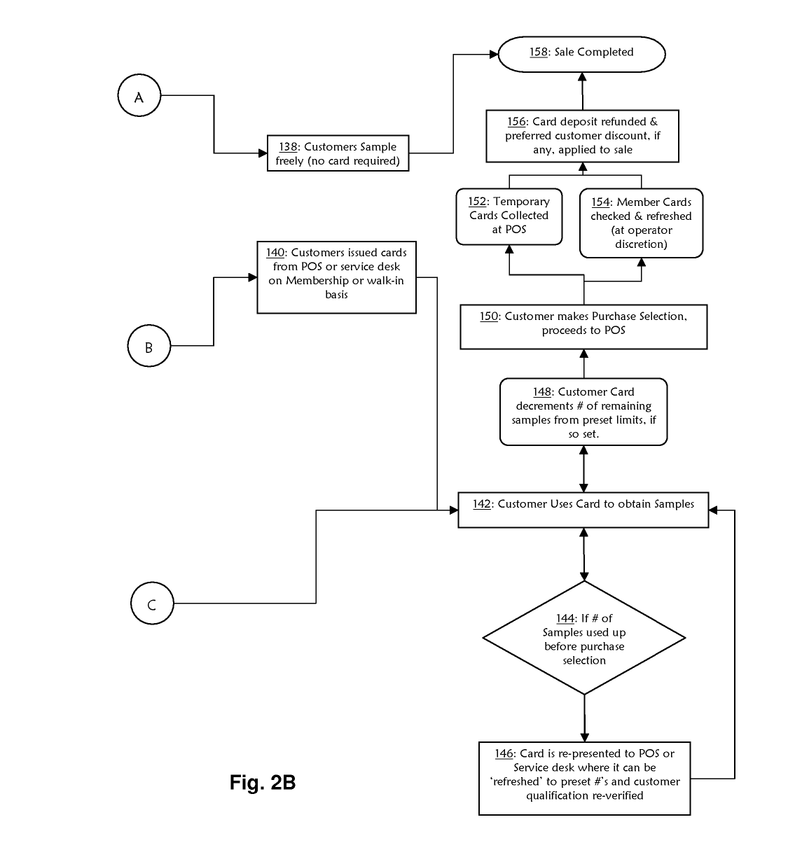

FIG. 2 illustrates exemplary logic of methods in accordance with the present invention. As will be readily appreciated by those of ordinary skill in the art, a marketing system of the present invention can be used to market particular beverages (potable liquids) or sets of beverages. Examples of beverages that can be used in the present invention include, but are not limited to: wine, including fortified wine; beer; fruit juices; coffee; tea; water; distilled spirits; soda; and any other beverage. Because of the flexibility of the system, numerous marketing systems can be built. For example, the dispensing system can be loaded with wines from or of: a single vineyard; a single winemaker; a single appellation or region; a single style; a single grape varietal; a single blend type; a single price or price range; a single critic's reviews for one or more time periods; a single or range of ratings by a person or entity (e.g., critic); or combinations thereof. In this way, the merchant or proprietor, or in general the host of the tasting, can select a set of wines to market through the dispensing system of the present invention, advantageously utilizing the identification (e.g., card) system described herein, permit potential buyers to taste the beverages that are in the selected set against other beverages in that set, while offering the potential of exact pour amounts and attendant-less operation of the tasting itself.

With continued reference to FIG. 2, card control and fee-based uses are independent parallel channels of the logic of the present invention. While the controls have nothing to do with money, the tasting program itself optionally may, i.e., the merchant or proprietor or marketer or host of a tasting can optionally charge a set or variable fee for a user to be given access to the system, e.g., given a User Card, either at a flat rate or a price schedule based on factors such as number of tastings, frequency of tastings, beverages actually purchased, and the like. Thus, internally the dispensing function is controlled by, e.g., card encoding, whereas time/fee-related use of the card may be part of the data associated with that user, e.g., a notation on the surface of the card, data held in a database in the ECU and/or the POS 26, or both.

Further optionally, the logic of the present invention can include time-based functionality in the processor and encoding the card with an activation period of an operator's choosing. Optionally, ‘surface treatment’ of the User Card for expirations may be used instead of a (less preferred) clock-based system. Thus, while the logic illustrated in FIG. 2 includes surface time constraints, the logic can alternatively be configured to include an integral clock-encoding.

With specific reference to FIGS. 2A and 2B, an exemplary process and logic 100 initially determines 102 if sampling of the particular beverage product is desired and legal in the particular jurisdiction; if not, then, clearly, the system is not implemented. If so, the owner/operator of the system employs 104 a system and makes a tasting program available to users, e.g., customers. If the sample volume is to be limited 106, then the sample portion volume is preset 108 in the system; otherwise, it is determined 110 if sample quantity is to be limited. If the sample quantity is to be limited, the logic returns to setting the sample portion volume 108; if not, the logic proceeds to A (see FIG. 2B). After presetting 108 the sample portion volume, it is determined 112 if the program participants are to be limited in some fashion: if not, the logic proceeds to A; if so, the data/card control sampling program is created 114 by the operator. Thereafter, the customer cards are set at the Card Control Unit (CCU) 116 to limit the number of samples for the card, and the process proceeds to D. It is also determined or decided 118 if the program will be fee based: if not, the logic proceeds to B (see FIG. 2B); if so, it is then determined or decided 120 if sampling cards or privileges will be issued to walk-in persons, that is, to persons not previously associated with the program. If yes at decision 120, the CCU is deployed 122 to program customer cards; if not, then the person is invited to join the program. Also from decision 118, it is determined or decided if the program is member-based: if it is, then the CCU is deployed at step 122 as above; if not, then it is decided or determined 126 if membership in the program expires. If so, the membership expiration is defined on the card, e.g., by barcode tape or by hand, and the logic proceeds to 136.

From deployment 122 of the CCU, it is determined or decided 128 if the sample quantity is to be limited: if so, the customer card unit is set 132 at the CCU to limit the number of samples; if not, the customer cards are set 130 at the CCU to an unlimited number of samples. In either case, the logic moves along to the issuance 136 of a card, either as a membership card or a temporary card, after verification of age and identity of the person and payment of any fees, as determined or decided early in the process. Optionally, a new card has a preset limit on the number of samples. Thereafter, the process / logic proceeds to C (see FIG. 2B). For the exemplary embodiment of the present invention which does not use a programmable card, but instead utilizes a bar-code, biometric, passcode, or the like, the foregoing limitations of the customer's ability to sample is updated to a database record unique for that customer, located in the ECU or the system 26.

With continued reference to FIG. 2B, from A, the customers freely sample 138 the potable liquid using the system of the present invention, without the need for a card, and the program or sale is considered to end 158. From B, customers are issued 140 cards from a computerized system, e.g., a POS system, a customer service desk at the location hosting the system, or the like, based on the membership criteria previously established or on a walk-in basis. From the issuance 140 of cards, or from C, the customer uses 142 the card to activate the system to permit sampling, as described herein. If it is determined 144 that the number of samples taken using the card equals the number allotted to the card before a purchase has been made, the card can be re-presented 146 at a, e.g., POS machine or a customer service desk, where the card can be refreshed to the preset number of samples, and the customer's qualification for participation in the program (e.g., age) reverified; therafter, the customer can again use 142 the card to obtain samples.

At each use of the card, the system decrements 148 the number of remaining samples for which the card can be used, for cards that have such limits. When the customer makes a purchase selection 150, and proceeds to a POS, temporary cards can be collected 152 at the POS (e.g., cashier), and membership cards can be checked and/or refreshed 154. If there had been a card deposit made, it can be refunded and an optional preferred customer discount can be applied to the sale. Thereafter, the sale is considered complete 158.

In the foregoing, reference has been made to a card-based system merely for ease in explaining various aspects of the invention, but the invention is not limited to programmable card-based systems. Indeed, when a non-programmable, customer identifier is instead used, e.g., a bar-code that the customer carries with her, a biometric (clearly also carried with the customer), or the like, then the several decisions and/or determinations described above are instead associated with the customer within the system itself, rather than being encoded into a programmable card. In this other exemplary embodiment, the customer merely permits the reader 22 to examine the barcode or the person herself (e.g., by placing a digit on a fingerprint scanner), which then identifies the customer and permits the particular access defined by the system and data is stored by the system representative of the visit by the customer to the system and their activity with the system.

While the invention has been described in detail with reference to exemplary embodiments thereof, it will be apparent to one skilled in the art that various changes can be made, and equivalents employed, without departing from the scope of the invention. The foregoing description of the preferred embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable one skilled in the art to utilize the invention in various embodiments as are suited to the particular use contemplated. It is intended that the scope of the invention be defined by the claims appended hereto, and their equivalents. The entirety of each of the aforementioned documents is incorporated by reference herein.

I claim:

1. A method of marketing at least one potable liquid to a potential buyer, the method comprising:
positioning a dispensing mechanism in a retail location, the dispensing mechanism including at least one container of the at least one potable liquid, at least one controllable valve controlling the flow of liquid from the at least one container, an electronic control unit in control signal communication with the at least one controllable valve, and a data reader accessible by the potential buyer in data communication with the electronic control unit;
reading data from the potential buyer indicating to the electronic control unit that the potential buyer is authorized to use the dispensing mechanism; and
dispensing a predetermined volume of the at least one liquid from the at least one container through the at least one valve.

2. A method according to claim 1, wherein the at least one potable liquid is wine.

3. A method according to claim 1, wherein reading data comprises reading data from a source selected from the group consisting of a programmable card, a non-programmable card, a biometric, a passcode, and combinations thereof.

4. A method according to claim 1, further comprising:
defining a membership-based affinity program; and
authorizing only members of the affinity program to use the system.

5. A method according to claim 4, further comprising:
requiring a fee for membership in said affinity program.

6. A method according to claim 4, wherein said affinity program is time-limited.

7. A method according to claim 1, further comprising:
giving a monetary discount to the potential buyer after said dispensing when the potential buyer purchases a container of said at least one potable liquid.

8. A method according to claim 1, further comprising:
repeating said reading data and said dispensing.

9. A method according to claim 8, wherein said repeating said reading data and said dispensing is performed a predetermined, limited number of times.

10. A method according to claim 1, further comprising:
decrementing a counter each time said dispensing is performed.

11. A method according to claim 10, wherein decrementing comprises decrementing a counter contained on a programmable card.

12. A method according to claim 11, further comprising:
increasing said counter when the potential buyer purchases a container of at least one liquid.

13. A method according to claim 1, wherein the dispensing mechanism further includes a database including a counter for each potential buyer, and wherein decrementing comprises decrementing the database counter for the potential buyer.

14. A method according to claim 10, further comprising:
increasing said counter manually or after a predetermined time period.

15. A method according to claim 1, wherein the at least one container comprises at least two containers, the at least one controllable valve comprises at least two controllable valves, and the predetermined volume is a first predetermined volume, and further comprising:
calibrating the dispensing mechanism to dispense the first predetermined volume from a first of the at least two containers, and to dispense a second predetermined volume from a second of the at least two containers, the first and second predetermined volumes being different.

16. A method of dispensing at least one potable liquid to a buyer from a merchant's designated operator, the method comprising:
positioning a dispensing mechanism in a retail location, the dispensing mechanism including at least one container of the at least one potable liquid, at least one controllable valve controlling the flow of liquid from the at least one container, an electronic control unit in control signal communication with the at least one controllable valve, and a data reader in data communication with the electronic control unit;
reading data from the operator indicating to the electronic control unit that the operator is authorized to use the dispensing mechanism;
dispensing a volume of the at least one liquid from the at least one container through the at least one valve; and
giving the volume of the at least one liquid to the buyer.

17. A method according to claim 16, further comprising:
determining that the buyer is of an age permitted to consume alcohol before said giving.

18. A method according to claim 16, wherein reading data comprises reading data from a source selected from the group consisting of a programmable card, a non-programmable card, a biometric, a passcode, and combinations thereof.

19. A method according to claim 16, wherein said volume is a predetermined volume.

20. A method according to claim 19, wherein the at least one container comprises at least two containers, the at least one controllable valve comprises at least two controllable valves, and the predetermined volume is a first predetermined volume, and further comprising:
calibrating the dispensing mechanism to dispense the first predetermined volume from a first of the at least two containers, and to dispense a second predetermined volume from a second of the at least two containers, the first and second predetermined volumes being different.

21. A method according to claim 16, wherein said at least one potable liquid is wine.

22. A system useful for controlled dispensing of potable liquid, comprising:
a housing having an exterior and configured and arranged to hold at least one container of a potable liquid;
at least one controllable valve configured and arranged to control the flow of liquid from at least one container when positioned in the housing;
an electronic control unit in control signal communication with the at least one controllable valve;
at least one control switch for each at least one controllable valve, the at least one control switch in signal communication with the electronic control unit;
a data reader on said housing exterior in data communication with the electronic control unit, the data reader configured and arranged to read data indicative of a user's authorization to operate the system;
wherein the electronic control unit is configured and arranged to enable the at least one controllable valve to dispense liquid therethrough when the data reader communicates to the electronic control unit that data indicative of a user's authorization to operate the system has been read, and when the at least one control switch has been operated.

23. A system according to claim 21, further comprising:
the at least one container of the at least one potable liquid positioned in said housing.

24. A system according to claim 21, wherein the at least one potable liquid is wine.

25. A system according to claim 22, further comprising:
a source of compressed gas in fluid communication with the at least one container of at least one potable liquid; and
at least one dip tube in each at least one container, the at least one dip tube in fluid communication with each at least one controllable valve.

26. A system according to claim 22, wherein each at least one container is vertically aligned with each at least one control switch.

27. A system according to claim 22, wherein each at least one control switch corresponds to each at least one valve and to each at least one container with which said at least one control switch is vertically aligned.

28. A system according to claim 22, wherein the data reader is configured and arranged to read a data source selected from the group consisting of a programmable card, a non-programmable card, a biometric, a passcode, and combinations thereof.

29. A system according to claim 22, further comprising:
a computing device including logic configured and arranged to receive data from said data reader, and configured and arranged to receive data from said electronic control unit.

30. A system according to claim 29, wherein the computing device includes a user-readable display, the computing device configured and arranged to output information on the display concerning at least one potable liquid.

31. A system according to claim 30, wherein the computing device further comprises:
a user-input device;
logic configured to receive data from the user-input device indicative of a choice to dispense liquid from the at least one container; and
logic configured to control the electronic control unit to dispense liquid from the at least one container.
